(19) United States
(12) Patent Application Publication
(10) Pub. No.: US 2011/0318454 A1
(43) Pub. Date: Dec. 29, 2011

(54) NUTRITIONAL BEVERAGE AND A METHOD OF MAKING THE SAME

(75) Inventors: Jurg Obrecht, Basel (CH); Sylvain Roger Laperche, Basel (CH)

(73) Assignee: Novozymes A/S, Bagsvaerd (DK)

(21) Appl. No.: 13/201,047

(22) PCT Filed: Mar. 19, 2010
(86) PCT No.: PCT/EP2010/053620

§ 371 Date: Aug. 11, 2011

Related U.S. Application Data
(60) Provisional application No. 61/161,925, filed on Mar. 20, 2009.

(30) Foreign Application Priority Data
Mar. 20, 2009 (EP) 09155709.0

(51) Int. Cl. A23L 1/20

(52) U.S. Cl. 426/46

(57) ABSTRACT

A refreshingly acidic beverage which is a potent mineralizing drink and a method of making it is described. It is made from grains, preferably barley and soy and contains physiological supplements of calcium, magnesium and amino acids that can be well assimilated. The method involves use of enzymes, including a carbohydrate oxidase and a catalase during brewing.

### FIELD OF THE INVENTION

This invention relates to a refreshingly acidic beverage which is a potent mineralizing drink and a method of making it. It is made from grains and contains physiological supplements of calcium, magnesium and amino acids that can be well assimilated. The method involves use of enzymes, including a carbohydrate oxidase and a catalase in wort produced in brewing

### BACKGROUND OF THE INVENTION

Milk is a natural beverage that contains essential nutrients and minerals for the growth and maintenance of life. It is a rich source of proteins, minerals; for example calcium, magnesium and phosphorous and vitamins; for example, vitamin A, B, D. Regular drinking of milk is recommended to reduce the risk of osteoporosis, hypertension and colon cancer

However there are also arguments against drinking of milk. For example, it is known that some of the adults cannot digest lactose present in the milk. The ingestion of milk of animals, especially cows, has been shown to be associated with allergies, anaemia, autism, diabetes, and cancer.

There are many efforts to duplicate milk's benefits, in manufactured, new-age beverages. For example, beverages have been made with plant sources, for example, soy milk, rice milk. However, none are as wholesome, nutritious and delicious as milk.

There still exists a need for improved beverages which are effective milk substitutes and still are wholesome, nutritious and delicious.

### SUMMARY OF THE INVENTION

In one aspect, the invention relates to a method of making a non alcoholic beverage comprising:
a) Providing a wort;
b) Contacting the wort with a carbohydrate oxidase and a catalase;
c) Obtaining the beverage.

In another aspect, the invention relates to a beverage comprising:
a) Calcium
b) Magnesium
c) Free Amino Nitrogen (FAN)
d) Aldonates
e) Acidic pH.

In one aspect, the wort also contains a legume component, for example, soy flour.

In another aspect, the carbohydrate oxidase is a glucose oxidase or a lactose oxidase.

In one aspect, the beverage is further diluted with water or fruit juice before packing or consumption.

### DETAILED DESCRIPTION OF THE INVENTION

In one aspect, the invention relates to a method of making a non-alcoholic beverage comprising:

a) Providing a wort;
b) Contacting the wort with a carbohydrate oxidase and a catalase;
c) Obtaining the beverage.

The term wort has the conventional meaning in the art. It is the liquid filtered and obtained from the mash after lautering step in the brewing process. A conventional brewing process may be outlined in the following way: The starting material is malted (i.e. dampened, germinated and subsequently dried) barley or other malted grains (for example, sorghum) and/or unmalted adjuncts, called the grist. During the mashing step, where the grist is grounded and mixed with water, heated and stirred, the carbohydrates are degraded to fermentable sugars by the aid of the enzymes naturally present in the malt. After mashing, it is necessary to separate the liquid extract (the wort) from the solids (spent grain particles and adjuncts) in order to get clear wort. This process is described as lautering or mash filtration. After lautering, hops are added to the wort and then the wort is boiled. Boiled cooled and filtered wort is then aerated and fermented with yeast. The fermented beer is filtered and packed. The wort of this invention may be made from malted grains or from unmalted grains or combination of both. Examples of grains that can be used for making wort include all cereals, for example, barley, wheat, spelt wheat, rye, oats, triticale, rice, corn, buck wheat, quinoa, amaranthus, sorghum, other millets etc. The grist may also include other starch containing materials, for example but not limited to, sago, chestnut etc.

In one aspect, the wort also contains a legume component.

The phrase “legume component” denotes a legume(s) or a product obtained from legumes.

A legume is a plant in the family Fabaceae (or Leguminosae), or a fruit of these specific plants. Well-known legumes include, for example, soybean, alfalfa, clover, peas, beans, lentils, lupins, mesquite, carob, and peanuts. A legume product may be, for example, the flour obtained from legume seeds. Another example is syrup obtained after crushing treatment of legumes. Other examples include the protein isolate and the protein concentrate obtained from the legumes. For example, Soy protein isolate and Soy protein concentrates are known in the art. Soy protein isolate is a highly refined or purified form of soy protein with a minimum protein content of 90% on a moisture-free basis. It is made from defatted soy flour which has had most of the non-protein components, fats and carbohydrates removed. Soy protein concentrate is about 70% soy protein and is basically defatted soy flour without the water soluble carbohydrates. It is made by removing part of the carbohydrates (soluble sugars) from dehulled and defatted soybeans.

The used enzymes and their compositions are known to a person skilled in the art. Enzyme composition may also contain other stabilizers that help stabilise the enzyme. The compositions of the invention may be in any form suited for the use in question, e.g. in the form of a dry powder or granulate, in particular a non-dusting granulate, a liquid, in particular a stabilized liquid, an immobilized form or a protected enzyme. Granulates may be produced, e.g. as disclosed in U.S. Pat. No. 4,106,991 and U.S. Pat. No. 4,661,452 (both to Novo Industri A/S), and may optionally be coated by methods known in the art. Liquid enzyme preparations may, for instance, be stabilized by adding nutritionally acceptable stabilizers such as a sugar, a sugar alcohol or another polyol, lactic acid or another organic acid according to established methods. Protected enzymes may be prepared according to the method disclosed in EP 238,216.

The phrase “carbohydrate oxidase” refers to an oxidoreductase which has substrate specificity for carbohydrates. Oxidoreductases are enzymes that catalyze the transfer of electrons from one molecule to another. Dehydrogenases and oxidases belong to the enzyme class of oxidoreductases. Generally, dehydrogenases need the presence of a cofactor, e.g. NAD/NADP or a flavin coenzyme such as FAD or FMN, but this may also be the case for oxidases. Unless anything else is suggested, the enzymes described below and throughout the description are isolated enzymes with co-factor, if required.

One category of oxidoreductases, suitable for use in the present invention, is oxidases that catalyze an oxidation/reduction reaction involving molecular oxygen (O2) as the electron acceptor. In these reactions, oxygen is reduced to water (H2O) or hydrogen peroxide (H2O2). In particular carbohydrate oxidases that catalyse the conversion of maltose to maltose-delta-lactone that immediately de-composes in water to form maltobionate. The process generates hydrogen peroxide. The net reaction scheme may be described as:

Sugar+O2+H2O=Sugar acids+H2O2 (equation 1)

Aldonates are salts of Aldonic acids. An aldonic acid is any of a family of sugar acids obtained by oxidation of the aldehyde functional group of an aldose to form a carboxylic acid functional group. Thus, their general chemical formula is HOOC—(CHOH)n-CH2OH. Aldonic acids include, for example, gluconic and maltobionic acids. In one aspect of the invention, the carbohydrate oxidase enzymes convert the glucose and maltose in the wort to their respective aldonic acids. These aldonic acids are then converted to their respective calcium or magnesium salts.

A number of suitable carbohydrate oxidases capable of converting sugar to sugar acids are known and available to the skilled person. Examples of such carbohydrate oxidases are aldose oxidase, cellobiose oxidase (EC 1.1.99.18), pyranose oxidase (EC1.1.3.10), and hexose oxidase (EC1.1.3.5). By studying EC 1.1.3._, EC 1.2.3._, EC 1.4.3._, and EC 1.5.3._ or similar enzyme classes based on the recommendations of the Nomenclature Committee of the International Union of Biochemistry and Molecular Biology (IUBMB), other examples of useful carbohydrate oxidases are easily recognized by one skilled in the art.

A preferred carbohydrate oxidase is a microbial carbohydrate oxidase, in particular an isolated carbohydrate oxidase. Another preferred carbohydrate oxidase is Gluzyme™ available commercially.

Lactose Oxidases, according to this invention, are enzymes that have at least one of hexose oxidase activity (for example hexose oxidase), cellobiose oxidase activity (for example, cellobiose oxidase) or maltose oxidase activity.

Hexose oxidase (EC1.1.3.5) is a carbohydrate oxidase capable of oxidizing several saccharides including glucose, galactose, maltose, cellobiose and lactose. Enzymes belonging to the class of hexose oxidases and/or Cellobiose oxidases are preferred enzymes in the present invention. Hexose oxidases are produced naturally by several marine algal species. Such species are i.e. found in the family Gigartinaceae which belong to the order Gigartinales. Examples of hexose oxidase producing algal species belonging to Gigartinaceae are Chondrus crispus and Iridophycus flacci. Also algal species of the order Cryptomeniales including the species Euthora cristata are potential sources of the hexose oxidase suitable for use in the present invention. In particular, Hexose oxidases suitable for use in the present invention are for example extracted from the red alga Iridophycus flaccidum (Bean and Hassid, 1956, J Biol Chem 218: 425-436) or extracted from Chondrus crispus, or Euthora cristata as described in WO96/40935, which further describes cloning and recombinant expression of hexose oxidase from Chondrus crispus (SEQ ID NO: 30 and 31 of WO96/40935 are hereby incorporated by reference).

Cellobiose oxidase (EC 1.1.99.18) is a carbohydrate oxidase capable of oxidizing several saccharides including cellobiose, soluble cellooligosaccharides, lactose, xylobiose and maltose. Enzymes belonging to the class of cellobiose oxidases are also preferred enzymes in the present invention. Cellobiose oxidase is an extracellular enzyme produced by various wooddegrading fungi, such as the white-rot fungus Phanerochaete Chrysosporium, brown-rot fungus Coniophora Puteana and soft-rot fungi such as Monilia sp., Chaetomium, cellulolyticum, Myceliophthora (Sporotrichum) thermophila, Sclerotium rolfsii and Humicola insolens (Schou et al., 1998, Biochemical Journal 330: 565-571).

A suitable lactose oxidase is Novozym® 46019 obtainable from Novozymes. Another suitable enzyme is carbohydrate oxidase obtainable from Microdochium nivale deposited under CBS 100236.

Glucose oxidase (EC 1.1.3.4) is an enzyme that catalyses the reaction

Beta-D-glucose+O(2)=D-glucono-1,5-lactone+H(2)O(2) (equation 2)

Glucose Oxidase is also alternatively called Beta-D-glucose: oxygen 1-oxido-reductase, Dglucose-1-oxidase, Glucose aerodehydrogenase or even Glucose oxyhydrase. A preferred Glucose Oxidase is Gluzyme™ marketed by Novozymes.

Other suitable carbohydrate oxidases can be derived, e.g. from a mitosporic Pyrenomycetes such as Acremonium, in particular, A. strictum deposited under ATCC 34717 or A. strictum T1 (Lin et al., 1991, Biochimica et Biophysica Acta 1118: 41-47); A. fusidioides deposited under IFO 6813; or A. potronii deposited under IFO 31197. In a preferred embodiment, the carbohydrate oxidase is obtained from the source disclosed in (Lin et al., 1991, Biochimica et Biophysica Acta 1118: 41-47) as well as in JP5084074.

In another preferred embodiment the carbohydrate oxidase is a carbohydrate oxidase obtained from a fungus belonging to the genus Microdochium, more preferably wherein the fungus is Microdochium nivale and even more preferably wherein the fungus is the Microdochium nivale deposited under CBS 100236. The oxidase isolated from CBS 100236 is described in details in WO 99/31990 (SEQ ID NO: 1 and 2 of WO 99/31990 are hereby incorporated by reference).

It is also possible to use dehydrogenases with the present invention. Such dehydrogenase enzyme systems may be isolated from Psedomonas, in particular from P. ovalis, P. schuylkilliensis, P. graveolens (e.g. deposited under IFO 3460), P. fragi, P. iodinum, P. amyloderamosa (e.g. deposited under ATCC 21262) or P. cepacia (e.g. deposited under CBS 659.88 or CBS 658.88).

The amount of oxidase/dehydrogenase to be used will generally depend on the specific requirements and on the specific enzyme. The amount of oxidase addition preferably is sufficient to generate the desired degree of conversion of sugar to aldonate within a specified time. Typically, an oxidase addition in the range from about 1 to about 10000 OXU per kg of substrate is sufficient, particularly from about 5 to about 5000 OXU per kg of substrate, and more particularly from about 5 to about 500 OXU per kg of substrate. It is within the general knowledge of the skilled person to adjust the amount of specific enzyme needed for conversion of sugar to aldonate.

In the literature an Oxidase Unit (OXU) is normally defined as the amount of enzyme that oxidizes one μmol sugar per minute under specific conditions. For example, in the case of Glucose Oxidase, one unit of activity is defined as the amount of enzyme that will catalyse the oxidation of 1 micro mole of Glucose per minute at 25° C. under the assay conditions.

A catalase is an enzyme that catalyses the reaction: 2H2O2=O2+2H2O (equation 3).

A catalase (EC 1.11.1.6) is added to prevent limitation of the reaction driven by the carbohydrate oxidase and to eliminate unwanted H2O2 in the end-product. As described above carbohydrate oxidase is dependent on oxygen, but produces hydrogen peroxide. The advantage of adding catalase to the process of the present invention is that the carbohydrate oxidase is provided with oxygen and at the same time is the hydrogen peroxide which has strong oxidizing properties removed. A number of suitable catalases are known to the skilled person, for instance, the commercially available catalase, Catazyme™ from Novozymes A/S.

In one aspect of the invention, the carbohydrate oxidase and the catalase are added at the same time in step (b). In another aspect, the enzymes are added at different times, for example, the carbohydrate oxidase is added first and after some time the catalase is added. However, in the latter case, one has to contend with the generated H2O2, which might damage the beverage and also the enzyme activities.

A suitable combination is LactoYIELD®, a combination of lactose oxidase and catalase obtainable from Novozymes.

Oxygen is an important factor in the present process as the conversion of sugar to aldonates consumes oxygen (see equation 1 above). Accordingly, if the oxygen is monitored during the enzymatic reaction one will generally observe an initial drop in the oxygen amount, which, if e.g. air is constantly provided, will return to around the initial level, when the enzyme reaction terminates. When oxygen returns to more than 90% of the initial level the enzymatic reaction has ended or at least been significantly slowed down, indicating that all the substrate (e.g. starch, dextrin and/or maltose) has been processed to aldonate or an enzyme inhibition has occurred. Accordingly, a suitable incubation time could preferably be a time that at least lasts until the oxygen level in the production batch has returned to more than 90% of the initial level, especially if a maximum conversion of sugars is desired. Alternatively, the reaction can be monitored by the amount of base required to keep the pH constant. When the amount of base needed to maintain pH decreases it is an indication that the reaction has ended or at least been significantly slowed down. A decline in the enzyme reaction may, however, not only be due to exhaustion of the substrate. The enzyme stability over time is also a parameter that may affect the reaction. Consequently, if the enzyme is degrading over time this may also cause the reaction to be slowed down. In this case addition of substrate would not result in a renewed decrease in oxygen and pH. Suitable sources of oxygen include atmospheric air (approx. 20% oxygen), oxygen enriched atmospheric air (oxygen content >20%) and pure oxygen. Running the process under a pressure higher than 1 atmosphere increases the solubility of oxygen and may be preferred wherever applicable. The oxygen may be supplied to the process, e.g. by continuously mixing air into the reaction mixture during incubation.

Addition of a catalase and H2O2 can provide O2 to the reaction (see equation 3 above). Alternatively, the H2O2 naturally produced by the carbohydrate oxidase may be used. Use of H2O2 as an oxygen source may be particularly preferred when the process is carried out using immobilized enzymes where addition of oxygen is more difficult, or where foam formation, for example in protein containing reaction mixtures, is a problem due to the addition of oxygen by mixing air into the reaction. The catalase may be added at any suitable time e.g. together with the carbohydrate oxidase, or during the reaction, when the O2 level decreases, preferably the catalase is added at incubation start (time=0). An advantage of adding a catalase together with the carbohydrate oxidase is that the oxygen requirement can be significantly reduced (up to 50%). Thus, supply of oxygen, e.g. in the form of air may be significantly reduced. Actually, by adding an adequate amount of catalase together with H2O2 it is possible to omit oxygen supplementation completely. This extra-added H2O2 may originate from any commercial source.

Accordingly, a preferred embodiment of the present invention is where essentially all the oxygen required for the oxidation of sugars to aldonates is obtained by addition of a catalase, which generates the required oxygen by conversion of the available H2O2. If the amount of H2O2 is limiting to the process, additional H2O2 can be added.

In the present context the expression “essentially all of the oxygen” is used to describe the oxygen supply needed for the enzymatic reaction to work adequately and in particular that it is not necessary to actively add extra oxygen during the process.

In a preferred embodiment catalase is added in an amount that lowers the concentration of H2O2 as compared to a similar process without catalase. More preferably, the amount of catalase added to the process as described herein, is an amount that is sufficient to obtain at least 25%, 50%, 75%, 85% or 95% decrease in the amount of H2O2 as compared to a comparative control process where the only comparative difference is that catalase is not added, even more preferably the amount of catalase added to the process as described herein, is an amount that is sufficient to obtain a 100% decrease in the amount of H2O2 as compared to a comparative control process where the only comparative difference is that catalase is not added. Preferably, the catalase is added in an amount that also improves the degree of conversion of sugars to aldonates.

The contacting in step (b) is done such that conversion of the sugar, particularly glucose and/or maltose to aldonates occurs, preferably 10% or 15%, more preferably 20% or even 30% or 40% or 50% or 60% or 70%, or 80% or 90%, or even 95%, 99%, and 100% starch and/or maltose in the substrate is converted to aldonates.

The contacting step (b) must be performed under conditions allowing the carbohydrate oxidase to convert sugars to aldonic acids and/or aldonates. Such conditions include, but are not limited to, temperature, pH, oxygen, amount and characteristics of carbohydrate oxidase, other additives such as e.g. catalase and reaction/incubation time.

A suitable incubation time should allow the degree of conversion of sugars to aldonic acids of interest. Generally, a suitable incubation time is selected in the range from ½ hour to 3 days, preferably, from 2 hours to 48 hours, more preferably from 2 hours to 24 hours, most preferably from 2 hours to 18 hours.

The incubation temperature will generally depend on the carbohydrate oxidase used and is typically selected according to the optimal reaction temperature for the carbohydrate oxidase. However, as the solubility of oxygen decreases with increasing temperature, other factors have to be taken into account in order to obtain an optimal process. The skilled person will know how to balance the optimal temperature with respect to e.g. enzyme activity and oxygen solubility. Generally, a suitable temperature will be in the range from about 0° C. to about 99° C., preferably in the range of 5° C. to 90° C., more preferably in the range of 15° C. to 85° C., even more preferably in the range of 25° C. to 80° C., most preferably in the range of 25° C. to 60° C., even most preferably in the range of 25° C. to 45° C.

The optimal pH can vary dependent on the carbohydrate oxidase used. However, kinetic analysis of carbohydrate oxidase from Microdochium nivale (Nordkvist et al., 2007, Biotechnol Bioeng 97: 694-707) indicates that the use of strong bases (NaOH) may affect the stability of carbohydrate oxidases. Furthermore, WO 97/004082 describes that increased yields of lactobionate using carbohydrate oxidase can be obtained when the process is performed at a stable pH. Accordingly, in order to increase the aldonate yield of the present process it may be desired to maintain pH during the conversion of sugar to aldonate by adequate addition of a base, at a stable level. In specific embodiments the stable pH level is maintained in the range of from about 3.0 to about 9.0 by addition of a base. It is possible to maintain pH within the prescribed ranges using any base. In principle, any substance capable of neutralising the produced acid will be applicable in the process. The skilled person knows numerous bases that can be applied in the process of the invention, e.g. strong bases such as Ca(OH)2, KOH, NaOH and Mg(OH)2. In a preferred embodiment a weak base or carbonate is used to maintain the pH at a stable level. Examples of weak bases include, but are not limited to, CaCO3, MgCO3, Mg(OH)2, Na2CO3, K2CO3, (NH4)2CO3 and NH4OH, NaHCO3, KHCO3. Presently, preferred weak bases are CaCO3, MgCO3, and Mg(OH)2.

It will be appreciated that the pH of the aldonate product or beverage can also be adjusted to a preferred pH level after or at the end of the enzymatic conversion performed, e.g. when 95% of the desired conversion of maltose has been achieved, the pH may be allowed to drop to a desired level.

The pH of the beverage is generally in the range of 2.0 to 6.00, particularly in the range of 2 to 5.00, for example, in the range of 2.5 to 4.5, more particularly in the range of 2.5 to 4.0.

In the present context “a stable pH level” is to be broadly understood as the control and maintenance of pH during the process within a specific range, or close to/at a specific value by addition of a base. Control and adjustment/maintenance of pH during an enzymatic process is a standard procedure that can be carried out with a very high degree of accuracy. Thus, a stable pH may be a value maintained at a constant level with a variation of less than 1.5 pH unit, preferably less than 1.0 pH unit, more preferred less than 0.5 pH units, more preferred less than 0.3 pH units, even more preferred less than 0.2 or 0.1 pH units. It follows that an optimal range may be defined for a specific enzymatic process according to the present invention and that pH can be controlled and maintained with the described degree of accuracy within this range. In the process of the invention, a suitable specific pH range or specific pH value is selected in the range from about pH 3 to about pH 9.

It is preferred that pH is maintained at the stable pH level as described herein from the start of the enzymatic reaction. In other words, immediately after the oxidase is added to the glucose/maltose containing product the base is added to maintain the stable pH as described herein.

Particularly, if a maximum conversion of glucose/maltose is desired, the pH is maintained at the stable level as described herein for a period of time that at least last until the oxygen level of the reaction mixture has returned to more than 90% of the initial level, or the amount of base used to keep the pH constant corresponds to the desired degree of conversion.

Preferably, the pH is maintained at the stable pH level as described herein for a time period from 30 minutes to 3 days, preferably, from 2 hours to 48 hours, more preferably from 2 hour to 24 hours, most preferably from 2 hours to 18 hours.

Generally, and preferably when the carbohydrate oxidase used is a glucose oxidase, the mash is added with enzyme(s) that converts oligosaccharides and polysaccharides to shorter saccharides or disaccharides and/or also disaccharides to monosaccharides, e.g. maltose to glucose. This will help release more substrates for glucose oxidase. Enzymes that convert maltose to glucose are known to a person skilled in the art. These include, for example, amylases, glucoamylase and pullulanase. A preferred enzyme combination is Attenuzyme Flex™ available from Novozymes.

Amylases are capable of hydrolyzing starch to form oligosaccharides as a main product, in particular maltose, a process which is well known to the skilled person. Amylases are classified under EC3.2.1._ and include alpha amylase (EC 3.2.1.1), beta amylase (EC 3.2.1.2) and amyloglucosidase (EC 3.2.1.3).

The amylase may be derived from a bacterium or a fungus, in particular from a strain of Aspergillus, preferably a strain of A. niger or A. oryzae, or from a strain of Bacillus. Some examples are alpha-amylase, e.g. from Bacillus amyloliquefaciens, and amyloglucosidase, e.g. from A. niger. Commercial products include BAN™ and AMG™ (products of Novozymes A/S, Denmark), Grindamyl™ A 1000 or A 5000 (available from Danisco). Beta-amylase, or other starch degrading enzymes resulting in the formation of maltose, can likewise be used.

Glucoamylase (EC 3.2.1.3) is an enzyme that catalyses the hydrolysis of terminal (1->4)-linked alpha-D-glucose residues successively from non-reducing ends of the chains with release of beta-D-glucose. Alternatively, this enzyme is also called a Glucan 1,4-alpha-glucosidase, 4-alpha-D-glucan glucohydrolase, Amyloglucosidase, Exo-1,4-alpha-glucosidase or a Gammaamylase.

Pullulanase (EC 3.2.1.41) is an enzyme that catalyses the hydrolysis of (1->6)-alpha-Dglucosidic linkages in pullulan, amylopectin and glycogen, and in the alpha- and beta-limit dextrins of amylopectin and glycogen.

In one aspect, the legume component is Soy flour. Soy flour is usually made from roasted soybeans that have been grounded into a fine powder. The flour may be natural (with fat) or defatted, where the natural oils found in soybean are removed during processing.

In one aspect, the legume component is added to the wort. In another aspect, the legume component is added to the mash during mashing. When added to the mash, extra proteases and generally phytases may be additionally added.

Phytases are enzymes that hydrolyze phytate (myo-inositol hexakisphosphate) to myo-inositol and inorganic phosphate. Phytic acid or myo-inositol 1,2,3,4,5,6-hexakis dihydrogen phosphate (or for short myo-inositol hexakisphosphate) is the primary source of inositol and the primary storage form of phosphate in plant seeds. In fact, it is naturally formed during the maturation of seeds and cereal grains. In the seeds of legumes it accounts for about 70% of the phosphate content and is structurally integrated with the protein bodies as phytin, a mixed potassium, magnesium and calcium salt of inositol. The phosphate moieties of phytic acid chelates divalent and trivalent cations such as metal ions, i.a. the nutritionally essential ions of calcium, iron, zinc and magnesium as well as the trace minerals manganese, copper and molybdenum. A phytase is an enzyme which catalyzes the hydrolysis of phytate (myo-inositol hexakisphosphate) to (1) myo-inositol and/or (2) mono-, di-, tri-, tetra- and/or penta-phosphates thereof and (3) inorganic phosphate. In the following, for short, the above compounds are sometimes referred to as IP6, I, IP1, IP2, IP3, IP4, IP5 and P, respectively. This means that by action of a phytase, IP6 is degraded into P+one or more of the components IP5, IP4, IP3, IP2, IP1 and I. Alternatively, myo-inositol carrying in total n phosphate groups attached to positions p, q, r, . . . is denoted Ins(p, q, r, . . . )P.sub.n. For convenience Ins(1,2,3,4,5,6)P.sub.6 (phytic acid) is abbreviated PA. According to the Enzyme nomenclature database ExPASy (a repository of information relative to the nomenclature of enzymes primarily based on the recommendations of the Nomenclature Committee of the International Union of Biochemistry and Molecular Biology (IUBMB) describing each type of characterized enzyme for which an EC (Enzyme Commission) number has been provided), two different types of phytases are known: A so-called 3-phytase (myo-inositol hexaphosphate 3-phosphohydrolase, EC 3.1.3.8) and a so-called 6-phytase (myo-inositol hexaphosphate 6-phosphohydrolase, EC 3.1.3.26). The 3-phytase hydrolyses first the ester bond at the 3-position, whereas the 6-phytase hydrolyzes first the ester bond at the 6-position.

Useful phytases are described in WO 2003/066847; WO 2006/037327; WO 2006/037328; WO 2007/112739; WO 2008/092901.

In one aspect, the wort, in addition, may also be contacted with a phytase and/or an enzyme(s) that converts maltose to glucose.

In another aspect, the legume component is pre-liquefied. The term “Pre-liquefied” means that the legume component is pre-treated to reduce its viscosity. The starch that is present in the legume components, like for example, soy flour, is initially insoluble in water and forms granules. But when heated in water they begin to swell rapidly until they are many times their original size. Upon continued heating, the starch, in form of granules begins to disintegrate and the viscosity of the mixture begins to rapidly increase until it reaches a maximum where a paste is formed. The handling of thick starch pastes in manufacturing procedures presents difficulties. Therefore, it is desirable to treat the starch so as to liquefy the starch and reduce its viscosity. Methods of liquefaction are known to the person skilled in the art. For example, liquefaction can be done by treatment with enzymes or by acid treatment or by combinations of both. The enzymes useful for liquefaction are known in the art. They include, for example, the enzyme alpha amylase. These enzymes can be derived from bacteria or fungi. Some examples of useful enzymes are Termamyl™ and Fungamyl™. During liquefaction, optionally other compounds may also be present for example antioxidants.

When the legume component is present, the legume component is added at a ratio (Weight/Weight) of 5% or preferably 10% or 15% or 20% or 25% or even 33% to the grain component in the mash. When higher legume ratios are used, it may be necessary to adjust the pH to maintain the enzyme activity.

In one aspect, at least one protease is included in the mash or wort. Proteases are polypeptides having protease activity and are also referred to as peptidases, proteinases, peptide hydrolases, or proteolytic enzymes. Proteases may be of the exo-type that hydrolyses peptides starting at either end thereof, or of the endo-type that act internally in polypeptide chains (endopeptidases). Endopeptidases show activity on N- and C-terminally blocked peptide substrates that are relevant for the specificity of the protease in question. The term “protease” is defined herein as an enzyme that hydrolyses peptide bonds. It includes any enzyme belonging to the EC 3.4 enzyme group (including each of the thirteen subclasses thereof). The EC number refers to Enzyme Nomenclature 1992 from NC-IUBMB, Academic Press, San Diego, Calif., including supplements 1 5 published in Eur. J. Biochem. 1994, 223, 1 5; Eur. J. Biochem. 1995, 232, 1 6; Eur. J. Biochem. 1996, 237, 1 5; Eur. J. Biochem. 1997, 250, 1 6; and Eur. J. Biochem. 1999, 264, 610 650; respectively. The nomenclature is regularly supplemented and updated; see e.g. the World Wide Web (WWW) at www.chem.qmw.ac.uk/iubmb/enzyme/index.html. Proteases are classified on the basis of their catalytic mechanism into the following groups: Serine proteases (S), Cysteine proteases (C), Aspartic proteases (A), Metallo proteases (M), and Unknown, or as yet unclassified, proteases (U), see Handbook of Proteolytic Enzymes, A. J. Barrett, N. D. Rawlings, J. F. Woessner (eds), Academic Press (1998), in particular the general introduction part.

Any protease can be used for the invention. For example, Alcalase®, Flavourzyme®, Neutrase® available from Novozymes A/S can be used. It is also possible to use combinations of more than one protease to optimize the activity. A skilled person would be able to arrive at the optimum combinations, for example one could use a combination of 1:1 or even 2:1. When using a protease, it is also important to add the cofactor, if any. For example, Zinc can be added as a cofactor for Neutrase®. The amount of protease needed to be used is dependent on various factors for example, the mash quality, quantity etc and is known to a person skilled in the art.

In one aspect, the invention relates to a beverage comprising:
a) Calcium
b) Magnesium
c) Free Amino Nitrogen (FAN)
d) Aldonates
e) Acidic pH

Calcium and magnesium are minerals and are usually present in the hard water that is used the brewing. Mostly they are present in the hard water in form of carbonates. However, in another aspect, additional calcium and magnesium sources may be supplemented during the process. In one aspect, the additional calcium and magnesium source is added to the beverage. Calcium and Magnesium sources that can be used are known to a person skilled in the art. They include, for example, citrates, carbonates, phosphates, lactates, gluconates or chelates, for example, malates, aspartates or fumarates. When adding the additional mineral sources, it is useful to add the sources in such a way that the final beverage would have a concentration of calcium: magnesium that reflects the physiological levels, for example, 2:1. However, presence of excess amount of calcium and/or magnesium may affect the taste of the beverage. It is preferred that the beverage contains no more than of 0.1 mol/l of 10° P drink (=° Bx) of alkaline earth metals (Mg, Ca) (i.e 0.067 Ca and 0.033 Mg).

Free Amino Nitrogen (FAN) is a measure of the concentration of individual wort amino acids and small peptides (one to three units) which can be utilised by yeast for cell growth and proliferation. However since, according to this invention, the wort is not fermented, FAN is also a measure of the free amino acids available in the drink that can be readily assimilated upon drinking.

The concept of pH is known in the art. It is preferable that the beverage has an acidic pH. This imparts a refreshing taste to the beverage. The production of the aldonic acids during oxidation, decreases the overall pH of the beverage. Addition of calcium and magnesium as carbonate supplements will help to maintain pH at the desired level.

In one aspect, the beverage has no residual sweetness. Ways of removing residual sweetness is known to the person skilled in the art. One way of removing residual sweetness is for example by stirring the beverage overnight during oxidation.

In one aspect the beverage is used in the production of Kwas. Kwas, alternatively called Kvass or Kvas, is a popular “bread drink” made from grains.

In another aspect, the beverage is diluted further before packing or before consumption. Dilution can be done using for example water or fruit juice. When water is used, it can, be for example, carbonated water. According to the invention, the term “fruit juice” refers to citrus and non-citrus juices including vegetable juices. The fruit juice can be provided as juice made from, for example, apple, passion fruit, cranberry, pear, peach, plum, apricot, nectarine, grape, cherry, currant, raspberry, gooseberry, blackberry, blueberry, strawberry, lemon, lime, mandarin, tangerine, orange, grapefruit, potato, tomato, lettuce, celery, spinach, cabbage, watercress, dandelion, rhubarb, carrot, beet, cucumber, pineapple, coconut, pomegranate, kiwi, mango, papaya, banana, watermelon and cantaloupe. The term “fruit juice” also refers to water extracted soluble solids, fruit juice concentrates, comminutes and purees. Preferred fruit juices are malic acid containing fruit juices, for example apples, pear, peach etc.

In yet another aspect, the beverage is treated with 0.25-0.3% Hop Pellets (6% alpha acid) at 78-100° C. for 30 minutes to produce a “hopped” beverage.

In one aspect, the beverage is further added with a flavour agent. According to the invention, the term “flavour agent” refers to those flavors derived from the edible reproductive part of the seed plant, especially one having a sweet pulp associated with the seed, for example, apples, oranges, lemon, limes, etc. It also includes flavors derived from parts of the plant other than the fruit, for example, flavors derived from nuts, bark, roots and leaves. Also included within this term are synthetically prepared flavors made to simulate flavors derived from natural sources. Examples of flavour agents include cola flavors, tea flavours, cinnamon, allspice, clove, coffee flavours, citrus flavors including orange, tangerine, lemon, lime and grape fruit flavors. A variety of other fruit flavors can also be used such as apple, grape, cherry, pineapple, coconut and the like. In one aspect, fruit juices, including orange, lemon, tangerine, lime, apple and grape can be used as the flavour agent.

In one aspect, the beverage can be used as non-dairy refreshment drink containing juice. In another aspect, the beverage can be used as a sports drink, which is isotonic. In another aspect, the beverage can be used as a health drink containing reduced glycemic index carbohydrates, i.e. carbohydrates which cause only small fluctuations in blood glucose and insulin levels. In yet another aspect, the beverage can be used as an alcohol free pilsner draft beer.

### EXAMPLES

All reagents used were of commercial grade. All measurements were done as per the European Brewery Convention (EBC) methods. All enzymes were commercially available from Novozymes A/S, Bagsvaerd, Denmark.

### Example 1

134.75 g Soy flour was mixed with 1000 ml of water (containing 90 ppm Calcium), and 1000 ppm of Termamyl®classic (Novozymes A/S) was added. The contents were boiled for 20 minutes to get 1003.5 g (evaporation during boiling) of soy pudding.

37.2 g of soy pudding (equivalent to 5 g of soy flour) was mixed with 50 ml water and 0.10 g of 2:1 calcium-magnesium mixture (8.63 g CaCO3+4.04 g basic Mg-carbonate “40-45% MgO” (Riedel de Haen)). The mixture was incubated with the enzymes given in table 1A. After 60 minutes at 48° C., 50 g of malt (B-561, well modified) and 90 ml water (90 ppm Ca++) was added and the mash incubation continued for a regime of 30 minutes at 50° C.; 30 minutes at 63° C.; 30 minutes at 72° C.; 20 minutes at 78° C. At the end of the regime, the mash was made up to 275.00 g with water. The properties of the resulting mash was analyzed and the results are given in Table 1B.

TABLE 1A
shows the amount of enzymes added at different concentrations
(in parts per million (ppm) with respect to the quantity of Malt)
to the mash.

Trials

| | A | B | C | D |
|---|---|---|---|---|
| Alcalase 2.4 L | 500 | 500 | 500 | 500 |
| Neutrase 0.8 L | 500 | 500 | 500 | 500 |
| Ultraflo Max | 300 | 500 | 300 | 300 |
| Flavourzyme | 0 | 300 | 0 | 0 |
| Zinc++ | 0 | 50 | 50 | 50 |
| BAN 480 | 0 | 0 | 0 | 200 |
| Viscozyme L | 0 | 0 | 300 | 0 |
| Lipopan F BG | 0 | 300 | 300 | 300 |

TABLE 1B
this table shows the various parameters that were
analyzed and their values.

| Parameters: | A | B | C | D |
|---|---|---|---|---|
| final pH | 5.97 | 6.11 | 5.91 | 5.93 |
| Filtration, | 73.50 | 82.00 | 83.00 | 81.00 |
| ml after 10 min | | | | |
| FAN | 579 | 647 | 592 | 596 |
| ° Plato | 16.15 | 16.33 | 16.33 | 16.29 |
| Viscosity (cP) | −0.534 | −0.534 | −0.534 | −0.534 |

1250 mL of the wort produced was taken and 200 ppm lactose oxidase (Novozym® 46019) and 200 ppm Catalase (Catazyme® 25L) was added accompanied by vigorous stirring. The pH of the wort was allowed to drop to about 5.4. At this point, a mixture of 2 Calcium/1 Magnesium carbonates (8.63 CaCO3+4.04 basic Magnesium carbonate) was added to increase the pH to 5.7-5.8; this is repeated over a period of 5 hours (keeping the pH between 5.4 and 5.8). A total of 12.12 g (0.124 mol Me⁺⁺) of the basic mineral mixture was solubilised as aldonates. The resulting beverage was pasteurized. A delayed precipitate had formed after standing for 2 days at 4° C., pointing out a possible higher requirement of phytase

### Example 2

525 g of non dried, non defatted Soy bean was milled (0.1 mm) and mixed with 2000 ml of water (containing 180 ppm Calcium), and 1000 ppm of Termamyl®BrewQ (Novozymes A/S) was added. The contents were boiled for 40 minutes with continuous stirring to obtain soy pudding. 94.5 g of soy pudding (equivalent to 24.6 g of soy flour) was, mixed with 50 ml water and 0.10 g of 2:1 calcium-magnesium mixture (8.63 g CaCO3+4.04 g basic Mg-carbonate “40-45% MgO” (Fluka, Buchs, Switzerland). The mixture was mashed with the enzymes given in table 2 A. After 60 minutes at 48° C., 50 g of malt (B-561, well modified) with approximately 140 ml of water was added and the mash incubation continued for a regime of 30 minutes at 50° C.; 90 minutes at 63° C.; 30 minutes at 72° C.; 20 minutes at 78° C. At the end of the regime, the mash was made up to 350.00 g with water and filtered. The properties of the resulting mash was analyzed and the results are given in Table 2B

TABLE 2A
shows the amount of enzymes added at different concentrations
(in ppm with respect to the quantity of Malt) to the mash.

| | Trials | | | | | | | | | |
|---|---|---|---|---|---|---|---|---|---|---|
| | A | B | C | D | E | F | G | H | I | J |
| Alcalase2.4 L | 500 | 500 | 500 | 500 | 500 | 600 | 800 | 800 | 800 | 800 |
| Neutrase 0.8 L | 425 | 350 | 250 | 100 | 425 | 425 | 425 | 425 | 425 | 425 |
| Ultraflo Max | 200 | 200 | 200 | 200 | 200 | 200 | 200 | 200 | 200 | 0 |
| Flavourzyme | 250 | 250 | 250 | 250 | 250 | 300 | 400 | 400 | 400 | 400 |
| Zinc++ | 100 | 100 | 100 | 100 | 0 | 100 | 100 | 100 | 100 | 100 |
| Ca++/Mg++ Mix (g) | 0.25 | 0.25 | 0.25 | 0.25 | 0.25 | 0.25 | 0.25 | 0.15 | 0.08 | 0.08 |
| Attenuzyme flex | 500 | 500 | 500 | 500 | 500 | 0 | 0 | 0 | 0 | 0 |
| Bio-Feed Phytase L 4X | 300 | 300 | 0 | 300 | 300 | 500 | 500 | 500 | 500 | 500 |

TABLE 2B
this table shows the various parameters that were analyzed and their values.

| parameter: | A | B | C | D | E | F | G | H | I | J |
|---|---|---|---|---|---|---|---|---|---|---|
| final pH | 5.9 to 6.1 | | | | | | | | | |
| Filtration, | 64 | 62 | 67 | 68 | 60.5 | 64 | 64 | 69 | 68 | 63 |
| ml after 20 min | | | | | | | | | | |
| FAN | 729 | 700 | 673 | 665 | 664 | 743 | 821 | 800 | 808 | 770 |
| ° Plato | 15.57 | 15.64 | 15.48 | 15.47 | 15.64 | 15.75 | 15.88 | 15.81 | 15.84 | 15.74 |
| Viscosity (cP) | −0.534 | −0.534 | −0.534 | −0.534 | −0.534 | −0.534 | −0.534 | −0.534 | −0.534 | −0.534 |

550 mL of the wort produced was taken and 100 ppm of a lactose oxidase (Novozym® 46019) and 100 ppm Catalase (Catazyme® 25L) was added accompanied by vigorous stirring at 35° C., for 18 hours. The pH of the wort had dropped to 4.0 forming an agreeably acidic beverage.

### Example 3

17.3 g of soy pudding prepared in example 2, (equivalent to 5 g of soy flour) was mixed with 30 ml water and 0.10 g of 2:1 calcium-magnesium mixture (8.63 g CaCO3+4.04 g basic Mg-carbonate “40-45% MgO” (Fluka). The mixture was mashed with the enzymes given in table 3 A. After 60 minutes at 48° C., 50 g of malt (B-561, well modified) with approximately 175 ml of water was added and the mash incubation continued for a regime of 30 minutes at 50° C.; 90 minutes at 63° C.; 30 minutes at 72° C.; 20 minutes at 78° C. At the end of the regime, the mash was made up to 320.00 g with water and filtered. The properties of the resulting wort were analyzed and the results are given in Table 3B.

TABLE 3A
shows the amount of enzymes added at different concentrations
(in ppm with respect to the quantity of Malt) to the mash.

| | Trials | | | | | | |
|---|---|---|---|---|---|---|---|
| | A | B | C | D | E | F | G |
| | NO SOY | SOY | SOY | SOY | NO SOY | SOY | SOY |
| Alcalase2.4 L | 500 | 500 | 500 | 500 | 500 | 500 | 500 |
| Neutrase 0.8 L | 500 | 500 | 500 | 500 | 500 | 500 | 500 |
| Ultraflo Max | 500 | 500 | 500 | 500 | 500 | 500 | 500 |
| Flavourzyme | 300 | 300 | 300 | 300 | 300 | 300 | 300 |
| Zinc++ | 50 | 50 | 50 | 50 | 50 | 50 | 50 |
| Ca++/Mg++ Mix (g) | 0.07 | 0 | 0.07 | 0.07 | 0.07 | 0.04 | 0.03 |
| Attenuzyme flex | 0 | 0 | 0 | 500 | 500 | 500 | 500 |
| Phytase Ronozyme WX | 0 | 0 | 0 | 0 | 0 | 300 | 0 |
| Lipopan F BG | 300 | 300 | 300 | 300 | 300 | 300 | 300 |

TABLE 3B
this table shows the various parameters that were analyzed and their values.

| parameters: | A | B | C | D | E | F | G |
|---|---|---|---|---|---|---|---|
| final pH | 5.75 | 5.67 | 5.79 | 5.74 | 5.72 | 5.68 | 5.65 |
| Filtration, | 78.00 | 76.00 | 74.00 | 72.00 | 83.0 | 74.5 | 74.5 |
| ml after 8 min | | | | | | | |
| FAN | 400 | 499 | 485 | 491 | 392 | 482 | 468 |
| ° Plato | 12.82 | 13.57 | 1.59 | 13.69 | 12.90 | 13.59 | 13.62 |
| Viscosity (cP) | −0.534 | −0.534 | −0.534 | −0.534 | −0.534 | −0.534 | −0.534 |

450 mL of the wort produced was taken and 278 ppm each of a lactose oxidase (Novozym® 46019), Gluzyme 10000 BG, and Catalase (Catazyme® 25L) along with 0.9 g of Ca/Mg-mixture was added accompanied by vigorous stirring at 30° C. After 20 hours the pH had dropped to 3.5.

In a second oxidation trial, 300 ml of the wort produced was taken, 167 ppm lactose oxidase (Novozym® 46019), 167 ppm Glucose oxidase, 167 ppm catalase was added with vigorous stirring. After 4 hours at 37° C., a second dosage of the same enzymes is added and stirred overnight (14 hours). The pH had dropped to pH 3.20. The resulting beverage was pasteurized. This same procedure was repeated at 30° C. The resulting pH was 3.20, identical to the 37° C. trial).

### Example 4

A different kind of wort was made as follows: 50 g fermented rye (TUM, Munich) plus 170 g water (containing 120 ppm Ca++, 100 ppm Na+) were treated at 90° C. for 30 min with 500 ppm Ban 480L®, 1000 ppm Termamyl SC DS®, 500 ppm Biofeed phytase L 4x® (all available from Novozymes A/S, Bagsvaerd, Denmark). Cooled, 20 mL of water was added and a mashing regime 30′ 48° C.; 30′ 54°; 40′ 63°; 25′ 72°; 25′85° C. was applied. At the at start of 48° C.-ramp, 800 ppm of Novozyme 25008 9® was added and at the start of 63° C. ramp, Shearzyme® 2x-1000 ppm, Celluclast® conc BG-500 ppm, Lipopan F® BG-600 ppm, Neutrase® 0.8L-500 ppm, Ban 480 L®-500 ppm, Termamyl SC DS® 500 ppm and Biofeed Phytase L 4x-500 ppm was added. The contents were stirred at 150 rpm, cooled and made up to 250 g total. The wort obtained had a pH of 4.18 and 17.84° P and was very filterable (48 ml of filtrate at 10 min paper filtration). This is useful for Kwas-production

### Example 5

Another wort was made as follows: 50 g malted rye, 5.6 g barley malt, 0.2 g ca/mg-mixture and 100 ppm zn++ in 190 ml water was mashed for 35 min at 50° C. in mashing bath with 500 ppm Alcalase®, 400 ppm Neutrase®, 500 ppm Ultraflo Max® and 250 ppm Flavourzyme®. The pH was adjusted to 5.0 with dilute H3PO4, and mashing continued with a profile of 30′ 50° C., 90′ 63° C., 25′ 72° C., 15′ 78° C. and addition of 2000 ppm Attenuzyme Flex®, 1000 ppm Biofeed phytase L 4x®, 400 ppm Ultraflo Max® and 300 ppm Lipopan F BG®. Wort of pH 5.2, 633 FAN and 18.07° p with acceptable filterability was obtained. This can also be used for industrial Kwas production

### Example 6

600 ml of wort (obtained from 100% Malt in regular mashing), 2.2 g Ca/Mg mixture (20 g CaCO3 plus 10 g Magnesiumhydroxidcarbonate (Fluka) was mixed with 500 ppm Biofeed phytase CT 2x®, 333 ppm Catazyme 25L® and 333 ppm Novozyme 46019 and intensely stirred at 33-34° C. for 20 hours. At the end of this time, the pH of the wort had dropped to 3.85, and it tasted strongly acidic. 400 □l isomerized Hop extract (6% a-acid) was added and the beverage was pasteurized.

### Example 7

255 ml wort (17% soy, 20.6° P) was added to 70 ml water containing 1.5 g Ca/Mg-Mixture and treated with intense stirring at 33° C. for 18 hours along with 125 ppm Novozyme 46019 and Catazyme 25L. At 5 hours another equal enzyme dosage was added. The wort became agreeably acidic with a pH 4.3, and rather metallic taste due to high amino acid content. It was found ideal for blending.

### Example 8

Another kind of wort was made as follows: 193.2 g of soy pudding was mixed with 125 ml water and adjusted to a pH of 7.56 with dilute K2HPO4 (10.0 g in 32 ml water) and stirred well. This suspension was mashed at 48° C. for 50 min with 750 ppm Flavourzyme® 1000 L, 375 ppm Alcalase® 2.4 L, 200 ppm Neutrase® 0.8 L with stirring. The resulting slurry was cooled, adjusted to pH 5.8 with diluted H3PO4 and split onto 4 mashing beakers (corresponding to 15 g soy beans per beaker). To each beaker was added 75 g of malt, 180 ml water (100 ppm Ca++) and 400 ppm Ceremix® plus mg, 400 ppm Ultraflo Max®, 400 ppm Neutrase®, 750 ppm Biofeed Phytase® L 4x and masing was continued with a regime of: 30′ 52° C.; 45′ 62° C.; 20′ 72° C.; 20′ 78° C. and cooled. The wort had very good filterability with characteristics of 20.6° P, pH 5.73, 640 FAN.

### Example 9

400 ml wort (16° P) made from regular malt was mixed with 3.7 g Ca/Mg-Mixture, 250 ppm Catazyme, and 625 ppm Gluzyme 10000 BG and stirred intensely for 20 hrs at 35° C. The pH dropped to 3.32, with a trace of residual sweetness. It was found to be great for blending.

### Example 10

850 ml of Light-beer wort (11.7° P, high glucose), 1.5 g Ca/Mg-mixture, 120 ppm Novozyme 46019, 120 ppm Catazyme® and 300 ppm Attenuzyme Flex® was intensely stirred at 40-43° C. for 18 hrs and the pH dropped to 3.79.

### Example 11

300 ml of Rye wort (made from 90% rye and 10% Malt) and 0.8 g Ca/Mg-Mixture was treated at 32° C. for 20 hrs with 167 ppm Novozyme 46019 and 167 ppm Catazyme®. The pH dropped to 3.56, forming an agreeably tasting beverage. This can also be used for Kwas production.

### Example 12

300 ml of Rye wort (made from 90% rye and 10% Malt) and 0.8 g Ca/Mg-Mixture was treated at 34° C. for 20 hrs with 167 ppm Gluzyme® and 167 ppm Catazyme®. The pH dropped to 3.70.

### Example 13

360 ml wort (16.4° P) was treated with 100 ppm Gluzyme 10000 BG®, Attenuzyme Flex®, Catazyme 25L® at 30-35° C. for 2 hours. The wort was strongly sour after 2 hours. It was pasteurized with hops at 76° C.

1. A method of making a non alcoholic beverage comprising:
a) Providing a wort;
b) Contacting the wort with a carbohydrate oxidase and a catalase;
c) Obtaining the beverage;
wherein the pH of the beverage ranges from 2.5 to 4.5.

2. The method according to claim 1, wherein the wort comprises a legume component.

3. The method according to claim 2, wherein the legume component is soy flour.

4. The method according to claim 1, wherein the wort is made from a mash that comprises the legume component.

5. The method according to claim 4, wherein the mash further comprises a phytase.

6. The method according to claim 2, wherein the legume component is pre-liquefied.

7. The method according to claim 1, wherein the method further comprises addition of a calcium and/or magnesium source.

8. The method according to claim 1, wherein the carbohydrate oxidase is a Glucose Oxidase or a Lactose Oxidase.

9. The method according to claim 1, wherein the wort is made from a mash that comprises an enzyme that converts oligosaccharides and/or polysaccharides to shorter saccharides.

10. The method according to claim 1, wherein the method further comprises diluting the beverage.

11. The method according to claim 9, wherein the dilution is by addition of water or fruit juice.

12. The method according to claim 1, wherein the method further comprises addition of a flavor agent.
